(19) United States
(12) Patent Application Publication
(10) Pub. No.: US 2010/0165514 A1
(43) Pub. Date: Jul. 1, 2010

(54) HEAD SUPPORTING MECHANISM

(76) Inventors: Irizo NANIWA, Fujisawa (JP); Takuya Matsumoto, Hachioji (JP); Shigeo Nakamura, Odawara (JP); Shigeyuki Sasaki, Kasumigaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/625,620

(22) Filed: Nov. 25, 2009

(30) Foreign Application Priority Data
Nov. 28, 2008 (JP) JP2008-303374
Dec. 4, 2008 (JP) JP2008-310189

(51) Int. Cl. G11B 21/16

(52) U.S. Cl. 360/246.2; G9B/21.023

(57) ABSTRACT

A head supporting mechanism equipped with a waveguide is provided by which stiffness of the waveguide does not give a large influence to flying-heights and attitudes of a slider. In the head supporting mechanism, the waveguide provided on a suspension is arranged in such a manner that a portion of the waveguide is bent in either an in-plane direction or an out-plane direction of the suspension.

### INCORPORATION BY REFERENCE

The present application claims priorities from Japanese applications JP2008-303374 filed on Nov. 28, 2008, JP2008-310189 filed on Dec. 4, 2008, the contents of which are hereby incorporated by reference into this application.

### BACKGROUND OF THE INVENTION

The present invention is related to a head supporting mechanism equipped with a waveguide which guides laser light to a near-field optical element employed in a magnetic head constructed with a slider in an integral manner.

As one of techniques capable of considerably increasing recording density of hard disk drives, a heat assisted magnetic recording technique has been proposed. In a heat assisted magnetic recording technique, a very small area having a square defined by several tens of “nm” on a magnetic disk is heated at a temperature higher than, or equal to 200° C., and then, a magnetic field is applied to the heated very small area in order to record data on the magnetic disk. As means for heating the above-described very small area, such a technical idea is conceivable that laser light is converted into near-field light by a near-field optical element arranged in the vicinity of a recording magnetic pole, and then, the near-field light is utilized so as to heat this very small area.

Normally, a suspension of a magnetic head employed in a hard disk drives is constructed of a flexure and a load beam. The flexure is a thin plate-shaped elastic member which is directly joined to a slider, and has such a shape that the flexure does not restrict an attitude of the slider. The load beam is a plate-shaped member capable of applying weight via the flexure to the slider in a direction along which the weight is depressed against a disk plane. The flexure is joined to the load beam by welding.

As the above-described sort of head supporting mechanisms, for instance, JP-A-2003-6912 discloses the below-mentioned head supporting mechanism. That is, in this head supporting mechanism, while a portion corresponding to the flexure is formed by a cladding, a core through which light penetrates is formed at a center of the cladding. Since an edge plane of the core is provided in a half way of a waveguide and further on a fixing plane between the slider and the core, the light is once enlarged within the cladding, and thereafter, is deflected on a reflection plane on the side of a head. After the reflected luminous flux is collected by a micro lens, the collected luminous flux is irradiated to a near-field optical element. As a result, the light having high intensity can be conducted to the near-field optical element irrespective of attitudes of the head.

Also, as one technical idea related to the head supporting mechanisms, for example, the following technique has been disclosed by Seiko Instruments Inc., i.e., “Flying demonstration and analysis of pico slider with optical waveguide for heat assisted magnetic recording” (The 19th Magnetic Recording Conference (TMRC) 2008, Singapore, Jul. 29 to 31, in 2008). In this technical idea, such an idea that a waveguide should be fixed to which portion of a suspension is considered based upon calculations. A portion to which the waveguide should be fixed is changed in order to calculate spring constant, pitch constant, roll constant, flying-heights, and variations thereof, while utilizing a model in which one end of a waveguide spread over the suspension is directly connected to a slider, and further, another model in which one end of another waveguide spread over a suspension via a mirror between the suspension and a slider is connected to the mirror.

In addition, as another technical idea related to the head supporting mechanisms, for instance, JP-A-2001-101704 has disclosed a head supporting mechanism in which a waveguide is arranged on a rear plane of a head connecting plane of a flexure.

### SUMMARY OF THE INVENTION

A normal suspension has a structure that a flexure is patterned by an etching method so as to support a slider joining portion in a flexible manner. As a result, a slider may be stably flown over a disk with keeping a flying-height and an attitude, under which both positive pressure and negative pressure generated from an ABS (Air Bearing Surface) are balanced with a loading-force transferred from a load beam via a dimple, and thus, may also follow plane vibrations and wavinesses of the disk. Also, due to the above-described flexible supporting mechanism, even when the slider receives externally-applied shocks, and even in such a case that the slider is contacted to the disk and also contaminations present on the disk, the slider may be flown without crash.

However, in the head supporting mechanism described in JP-A-2003-6912, since the waveguide penetrates the slider joining portion in the straight line, the stiffness of the waveguide may largely give influences to the flying-heights and the attitudes of the slider. As a result, there is a risk that the stiffness of the waveguide may give an adverse influence to the stable flying of the slider. In addition, there are some possibilities that since the width and the thickness of the waveguide have the deviations, the stiffness of the waveguide also has the deviation, so that the deviations contained in the flying-heights and the attitudes of the slider are similarly increased. Also, even in the above-described TMRC 2008, since the waveguide is arranged on either the mirror or the slider in the straight line, the stiffness of the waveguide may largely give influences to the flying-heights and the attitudes of the slider. As a result, there is a risk that the stiffness of the waveguide may give an adverse influence to the stable flying of the slider.

Another technical idea may be conceived by which the waveguide is bent so as to escape the slider joining portion and the edge of the waveguide is elongated to the side of the magnetic head in a similar manner to that of an electric signal line provided on the flexure. However, in this technical idea, the waveguide must be largely bent. Nevertheless, in such a case that laser light of a single mode is utilized, the waveguide cannot be largely bent in view of an optical loss.

Further, in the head supporting mechanism disclosed in JP-A-2001-101704, since the waveguide is arranged on the rear side of the slider joining plane of the flexure, the distance defined from the light output of the edge of the waveguide to the head becomes long. As a result, there is a risk that the coupling loss of the light is increased.

The present invention is to provide such a structure that in a head supporting mechanism equipped with a waveguide, stiffness of the waveguide does not give an adverse influence to a flying-height and an attitude of a slider as being permitted as possible, while the waveguide is not largely bent.

Also, the present invention is to provide a head supporting mechanism capable of reducing a coupling loss of light between the waveguide and a head, and further, capable of realizing stable flying of the head, and to provide a hard disk drive equipped with the head supporting mechanism.

In the present invention, the above-described objects may be achieved by executing any of the below-mentioned methods:

(1) A portion of a waveguide is arranged by being bent in an in-plane direction of a suspension.

(2) A portion of a waveguide is arranged in such a manner that the portion of the waveguide is bent in an out-plane direction so as to be floated from the suspension.

(3) A portion of a waveguide is arranged in such a manner that the portion of the waveguide is bent in the in-plane direction and further in the out-plane direction so as to be floated from the suspension.

In other words, the present invention is featured by that in a head supporting mechanism equipped with: a slider having a write-element, a read-element, and a first waveguide, which is fixed to a tip portion of a flexure; and a second waveguide for guiding light to the slider, a tip portion of the second waveguide is fixed to the tip portion of the flexure, and a portion of the second waveguide, which is located on the side of a light source, is fixed to a root-sided portion of the flexure, which is connected to an arm; and the second waveguide has a free portion bent in an in-plane direction, an out-plane direction, or both the in-plane direction and the out-plane direction between the tip portion of the second waveguide fixed to the tip portion of the flexure, and the portion of the second waveguide fixed to the root-sided portion of the flexure. In the case that a sectional shape of the second waveguide is rectangular, it is preferable to make a thickness of the second waveguide smaller than, or equal to a half value of a width thereof.

Also, the present invention is featured by that a waveguide is arranged at a center portion of a slider joining plane of an elastic supporting member which elastically supports a slider, along a longitudinal direction of the slider joining plane; the waveguide is elongated from one end of the slider joining plane, which is located opposite to the magnetic head, a portion of the waveguide elongated from one end of the slider joining plane, which is located opposite to the magnetic head, is connected to either the elastic supporting member or a circuit member; and an auxiliary member having the substantially same thickness as a thickness of the portion of the circuit member is provided on the slider joining plane.

It should be understood that the auxiliary member is featured by such an auxiliary member having the substantially same thickness as that of the waveguide, which is arranged at both end portions of the slider joining plane along a longitudinal direction of the slider joining plane, and which is located parallel to the waveguide.

As a consequence, in such a case that the slider is joined to the slider joining plane of the elastic supporting member by an adhesive agent, the adhesive agent is filled into a space between the slider and the waveguide, and another space between the slider and a first auxiliary member, so that the slider can be joined with respect to the slider joining plane in higher precision.

The head-supporting mechanism according to the present invention can reduce the adverse influence caused by the stiffness of the waveguide, which is given to the flying-heights and the attitudes of the slider.

Also, in accordance with the present invention, the slider where the magnetic head has been formed at the edge portion thereof can be mounted on the slider joining plane of the elastic supporting member without any inclination, while the influences given to the flying-heights and the attitudes of the slider can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view for showing a hard disk drives to which the present invention is applied.

FIG. 2 is a diagram for indicating a tip portion of a head supporting mechanism according to an embodiment 1 of the present invention.

FIG. 3 is a sectional view of the head supporting mechanism, taken along a line A-A′ of FIG. 2.

FIG. 4 is a diagram for indicating a tip portion of a head supporting mechanism according to an embodiment 2 of the present invention.

FIG. 5 is a sectional view of the head supporting mechanism, taken along a line B-B′ of FIG. 4.

FIG. 6 is a diagram for indicating a tip portion of a head supporting mechanism according to an embodiment 3 of the present invention.

FIG. 7 is a sectional view of the head supporting mechanism, taken along a line C-C′ of FIG. 6.

FIG. 8A to FIG. 8F are diagrams for exemplifying a process executed in such a case that a waveguide is constructed with a flexure in an integral manner, according to an embodiment 4 of the present invention.

FIG. 9 is a diagram for representing calculation results of pitch constant in the embodiment 4.

FIG. 10 is a diagram for showing a structure inside a slider to which the present invention is applied.

FIG. 11 is an enlarged view for showing a tip portion of a head supporting mechanism according to an embodiment 5 of the present invention under such a condition that a slider has already been mounted.

FIG. 12 is an enlarged view for showing a tip portion of the head supporting mechanism according to the embodiment 5 of the present invention before the slider is mounted.

FIG. 13 is a sectional view for representing the tip portion, taken along a line A-A′ of FIG. 11.

FIG. 14 is an enlarged view for indicating a tip portion of a head supporting mechanism without having a waveguide 4, according to an embodiment 6 of the present invention.

FIG. 15 is a diagram for showing a condition of the head supporting mechanism indicated in FIG. 14 before the slider is mounted.

FIG. 16 is a graphical diagram for representing vibration characteristics of the head supporting mechanism, which indicate an effect of the embodiment 6 of the present invention.

### DETAILED DESCRIPTION OF THE INVENTION

In the following, embodiments of the present invention will be explained in reference with the drawings.

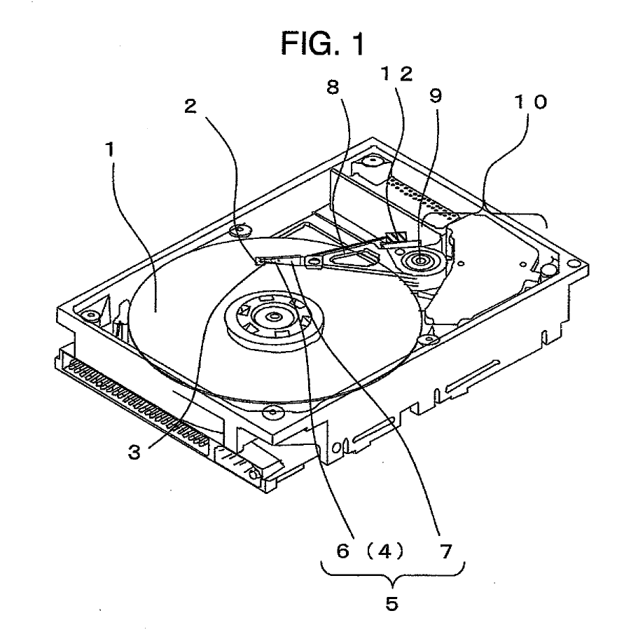

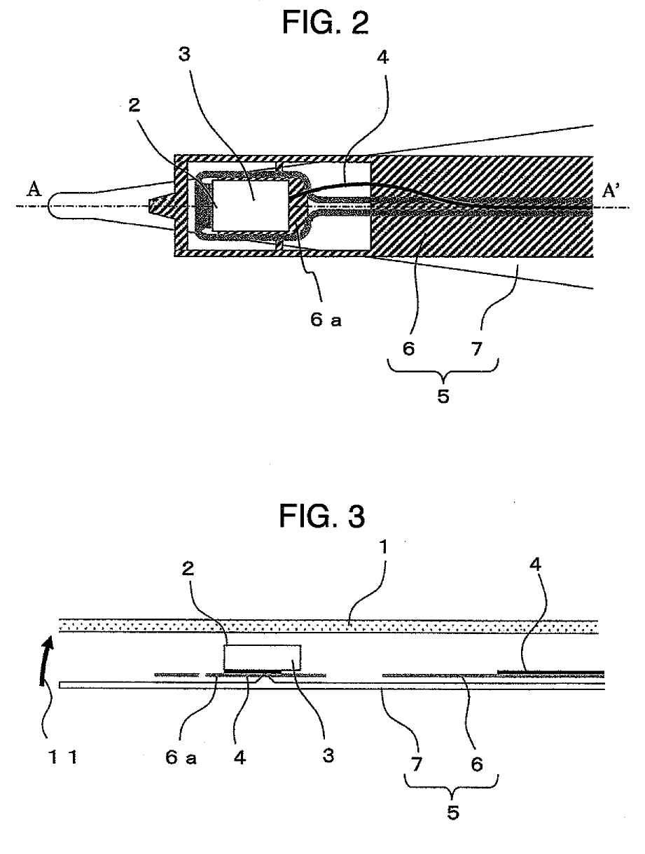

FIG. 1 is a perspective view for indicating an internal structure of a hard disk drives to which a head supporting mechanism of the present invention is applied. In the hard disk drives, a disk 1 corresponding to a magnetic recording medium is supported under rotatable manner. A magnetic head 2 equipped with a near-field light generating element is formed with a slider 3 in an integral manner, while the slider 3 is flown over a recording plane of the disk 1 with a predetermined interval. The slider 3 is supported by a suspension 5 equipped with a waveguide 4 (will be explained in FIG. 2 and subsequent drawings). The suspension 5 is constructed of a flexure 6 and a load beam 7, which are employed as elastic supporting members. The slider 3 is supported by the flexure 6 in a flexible manner under such a condition that an attitude of the slider 3 is not restricted. The suspension 5 is supported by a carriage arm 8, and the carriage arm 8 is supported in a swingable manner, while a pivot 9 is utilized as a rotation axis. The load beam 7 applies a loading-force via the flexure 6 to the slider 3 in a direction along which the slider 3 is depressed against the disk 1. Since a voice coil motor 10 is driven, the carriage arm 8 is swung while the pivot 9 is employed as the rotation axis, and thus, the magnetic head 2 equipped with the near-field light generating element is moved over desirable tracks so as to write and/or read information on/from the tracks.

It should be understood that the present invention is featured by an arrangement of the waveguide 4 (namely, second waveguide) which guides laser light from a laser light source 12 to the slider 3. As exemplified in FIG. 10, a magnetic head, a near-field light generating element 23, and a slider-installed waveguide 24 (namely, first waveguide) are arranged in a slider 3. The magnetic head is equipped with a write-element 21 for generating a recording magnetic field, and a read-element 22. The slider-installed waveguide 24 (of a first waveguide) is employed so as to irradiate laser light from the waveguide 4 to the near-field light generating element 23. However, the present invention has no feature with respect to the structures and the arrangement of the magnetic head and the slider-installed waveguide 24 provided in the slider 3, which are similar to those of the conventional technique. Accordingly, a detailed description of the structures provided in the slider 3 will be omitted in the below-mentioned explanations.

### Embodiment 1

A description is made of an embodiment 1 of a head supporting mechanism according to the present invention with reference to FIG. 2 and FIG. 3. FIG. 2 is a diagram for indicating a suspension tip portion of a hard disk drive to which the head supporting mechanism of the embodiment 1 is applied. FIG. 3 is a sectional view of the suspension tip portion, taken along a line A-A′ of FIG. 2.

The slider 3 is fixed on a tip portion 6a of a flexure 6 under such a condition that an attitude of the slider 3 is not restricted, and is supported in a flexible manner with respect to the flexure 6. A load beam 7 applies a loading-force via the tip portion 6a of the flexure 6 to the slider 3 in a direction along which the slider 3 is depressed against a disk 1. It should be understood that the above-described structure may be similarly applied to those of the below-mentioned other embodiments.

A tip portion of a waveguide 4 is fixed on the tip portion 6a of the flexure 6 in combination with the slider 3 so as to guide laser light to a waveguide within the slider 3. A portion of the waveguide 4 on the side of the laser light source 12 is fixed to a plane of the flexure 6, which is located opposite to another plane thereof to which the load beam 7 is joined, and the waveguide 4 has a free portion. The free portion of the waveguide 4 is arranged with being bent along an in-plane direction between the tip portion of the waveguide 4, which is fixed to the tip portion 6a of the flexure 6, and also a portion of the flexure 6, which is fixed on the side of the carriage arm 8. A sectional shape of the waveguide 4 is rectangular, and the bent portion of the waveguide 4 is not fixed to any structural component. In the bent portion of the waveguide 4, the waveguide 4 is gently curved by a radius of curvature of 15 mm, or longer than, or equal to 15 mm in order to suppress an optical loss.

In the present embodiment 1, the separately formed waveguide 4 has been joined to the flexure 6 and the tip portion 6a thereof by an adhesive agent. Alternatively, within a process for manufacturing the flexure 6, the waveguide 4 may be formed with the flexure 6 in an integral manner by employing a vapor deposition process, a printing process, a photolithographic process, an etching process, or a lift-off process.

In the present embodiment 1, the bent portion curved along the in-plane direction, which is not fixed to any structural component, is formed at such a waveguide between the tip portion of the waveguide 4, which is fixed to the portion 6a of the flexure 6, and also the waveguide portion of the flexure 6, which is fixed on the side of the carriage arm 8. As a result, this bent portion may become a play, so that the slider 3 can be flown under stable condition, while the waveguide 4 does not restrict free movement of the slider 3. Also, since the waveguide 4 is not largely bent, even when laser light of a single mode is employed, the optical loss caused by bending of the waveguide 4 can be suppressed to a low level, and laser light having high intensity can be irradiated to the near-field light generating element 23 arranged in the magnetic head 2, so that a recording area of the disk 1 can be heated in a high efficiency.

### Embodiment 2

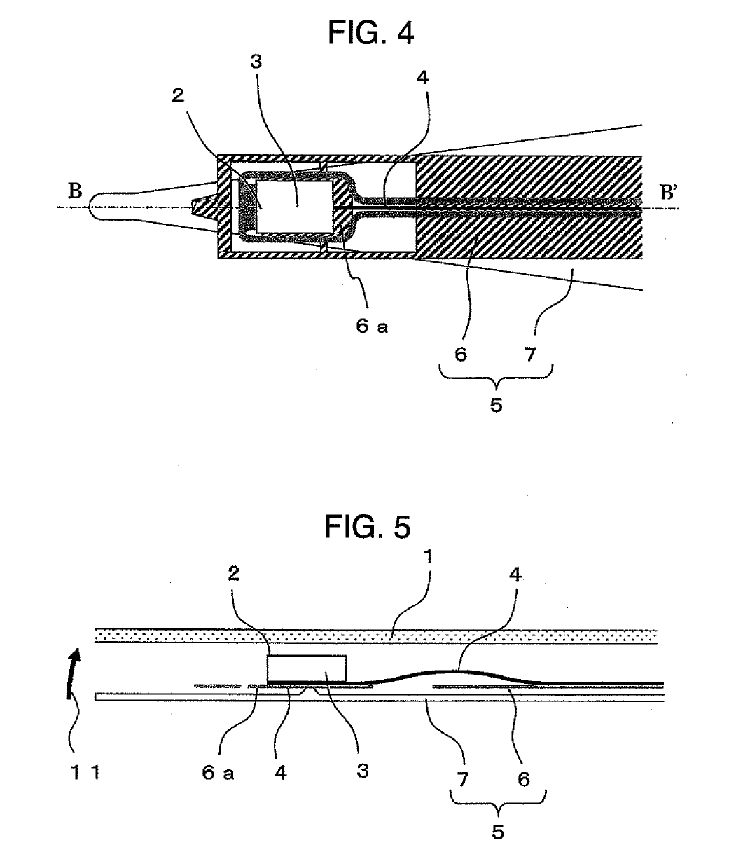

A description is made of an embodiment 2 of a head supporting mechanism according to the present invention with reference to FIG. 4 and FIG. 5. FIG. 4 is a diagram for indicating a suspension tip portion of a hard disk drive to which the head supporting mechanism of the embodiment 2 is applied. FIG. 5 is a sectional view of the suspension tip portion, taken along a line B-B′ of FIG. 4.

A tip portion of the waveguide 4 is fixed on the tip portion 6a of the flexure 6 in combination with the slider 3 so as to guide laser light to a waveguide provided within the slider 3. A portion of the waveguide 4 on the side of the laser light source 12 is fixed to a plane of the flexure 6, which is located opposite to another plane thereof to which the load beam 7 is joined, and the waveguide 4 has a free portion. The free portion of the waveguide 4 is arranged with being bent along an out-plane direction between the tip portion of the waveguide 4, which is fixed to the tip portion 6a of the flexure 6, and also a waveguide portion of the flexure 6, which is fixed on the side of the carriage arm 8. A sectional shape of the waveguide 4 is rectangular, and the bent portion of the waveguide 4 is not fixed to any structural component. In the bent portion of the waveguide 4, the waveguide 4 is gently curved by a radius of curvature of 15 mm, or longer than, or equal to 15 mm in order to suppress an optical loss.

In the present embodiment 2, the bent portion curved along the out-plane direction, which is not fixed to any structural component, is formed at such a waveguide between the tip portion of the waveguide 4, which is fixed to the tip portion 6a of the flexure 6, and also the portion of the waveguide 4, which is fixed to the flexure 6. As a result, this bent portion may become a play, so that the slider 3 can be flown under stable condition, while the waveguide 4 does not restrict free movement of the slider 3. Also, since the waveguide 4 is not largely bent, even when laser light of a single mode is employed, the optical loss caused by bending of the waveguide 4 can be suppressed to a low level.

### Embodiment 3

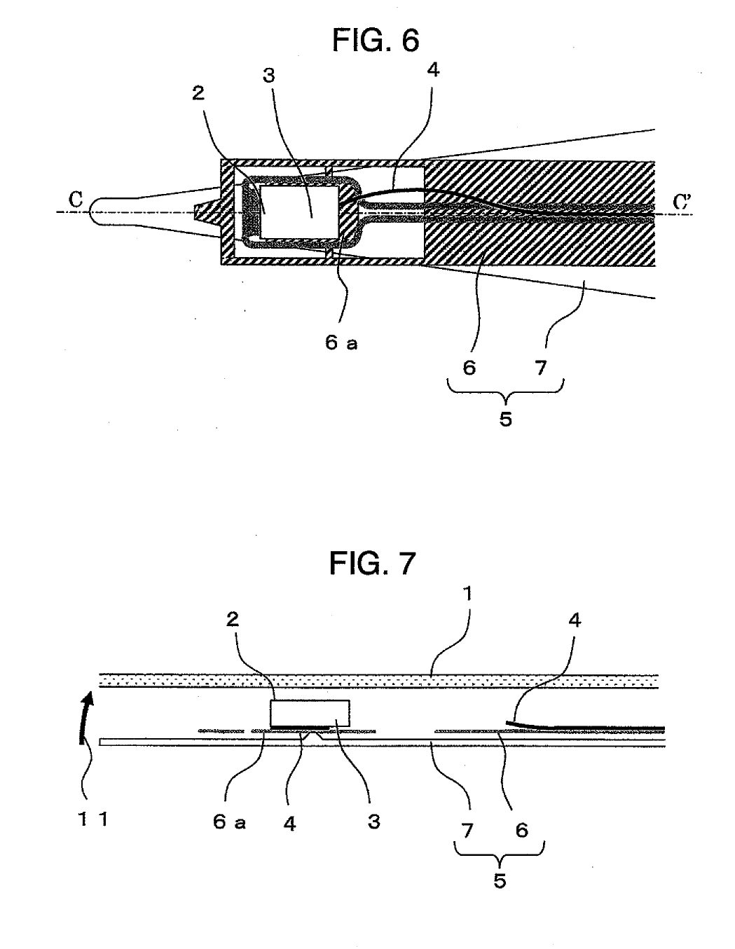

A description is made of an embodiment 3 of a head supporting mechanism according to the present invention with reference to FIG. 6 and FIG. 7. FIG. 6 is a diagram for indicating a suspension tip portion of a hard disk drive to which the head supporting mechanism of the embodiment 3 is applied. FIG. 7 is a sectional view of the suspension tip portion, taken along a line C-C′ of FIG. 6.

A tip portion of the waveguide 4 is fixed on the tip portion 6a of the flexure 6 in combination with the slider 3 so as to guide laser light to a waveguide provided within the slider 3. A portion of the waveguide 4 on the side of the laser light source 12 is fixed to a plane of the flexure 6, which is located opposite to another plane thereof to which the load beam 7 is joined, and the waveguide 4 has a free portion. The free portion of the waveguide 4 is arranged with being bent along an in-plane direction and also an out-plane direction between the tip portion of the waveguide 4, which is fixed to the tip portion 6a of the flexure 6, and also a portion of the waveguide 4 of the flexure 6, which is fixed on the side of the carriage arm 8. A sectional shape of the waveguide 4 is rectangular, and the bent portion of the waveguide 4 is not fixed to any structural component. In the bent portion of the waveguide 4, the waveguide 4 is gently curved by a radius of curvature of 15 mm, or longer than, or equal to 15 mm in order to suppress an optical loss.

In the present embodiment 3, the bent portion curved along the in-plane direction and the out-plane direction, which is not fixed to any structural component, is formed at such a waveguide between the tip portion of the waveguide 4 fixed to the tip portion 6a of the flexure 6 and the portion of the waveguide 4 joined to the flexure 6. As a result, this bent portion may become a play, so that the slider 3 can be flown under stable condition, while the waveguide 4 does not restrict free movement of the slider 3. Also, since the waveguide 4 is not largely bent, even when laser light of a single mode is employed, the optical loss caused by bending of the waveguide 4 can be suppressed to a low level.

### Embodiment 4

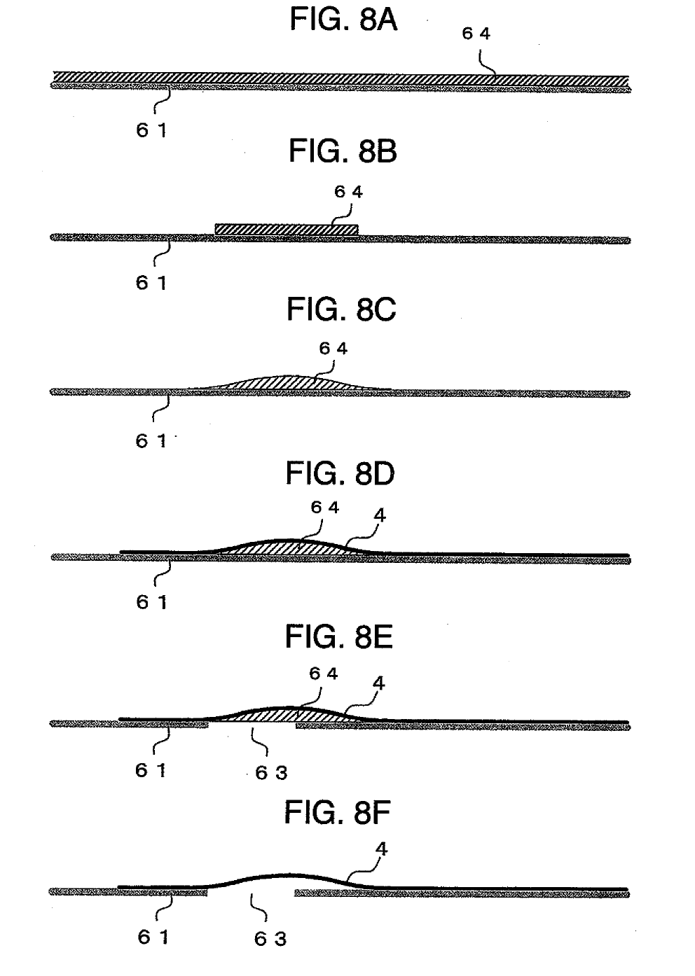

A head supporting mechanism according to an embodiment 4 of the present invention is featured by that the waveguide 4, the flexure 6, and the tip portion 6a of the flexure 6 of the head supporting mechanisms described in the embodiment 2 and the embodiment 3 are formed in an integral manner. A forming process of the above-described structural components is represented in FIG. 8A to FIG. 8F.

FIG. 8A: Firstly, a resist 64 is coated on a stainless substrate 61 of a flexure.

FIG. 8B: Next, a bent portion is patterned by photolithography.

FIG. 8C: Subsequently, the resist 64 is solidified in a reflow furnace so as to form a semispherical shape thereof. The semispherical shape will determine a shape of a bent portion of a waveguide.

FIG. 8D: Next, a waveguide 4 is formed by a vapor deposition manner on the semispherical-shaped resist 64.

FIG. 8E: The stainless substrate 61 of the flexure 6 is etched so as to pierce a hole 63 in a portion of the stainless substrate 61 to which the semispherical-shaped resist 64 has already been adhered.

FIG. 8F: The resist 64 is removed through the hole 63. As a result, the bent portion of the waveguide 4 is formed at a portion located just before the head 2, while the bent portion is floated in a space and is not fixed to any structural component.

Although the resist 64 has been patterned by employing the photolithography in the present embodiment 4, a printing technique may be alternatively employed. Further, in the present embodiment 4, after the resist 64 has been coated on the entire plane of the stainless substrate 61 and the coated resist 64 has been subsequently patterned, the patterned resist 64 is reflow-prossed so as to form the semispherical-shaped resist 64. Alternatively, since the resist 64 is coated by utilizing a dispenser and the like, the semispherical-shaped resist 64 may be directly formed.

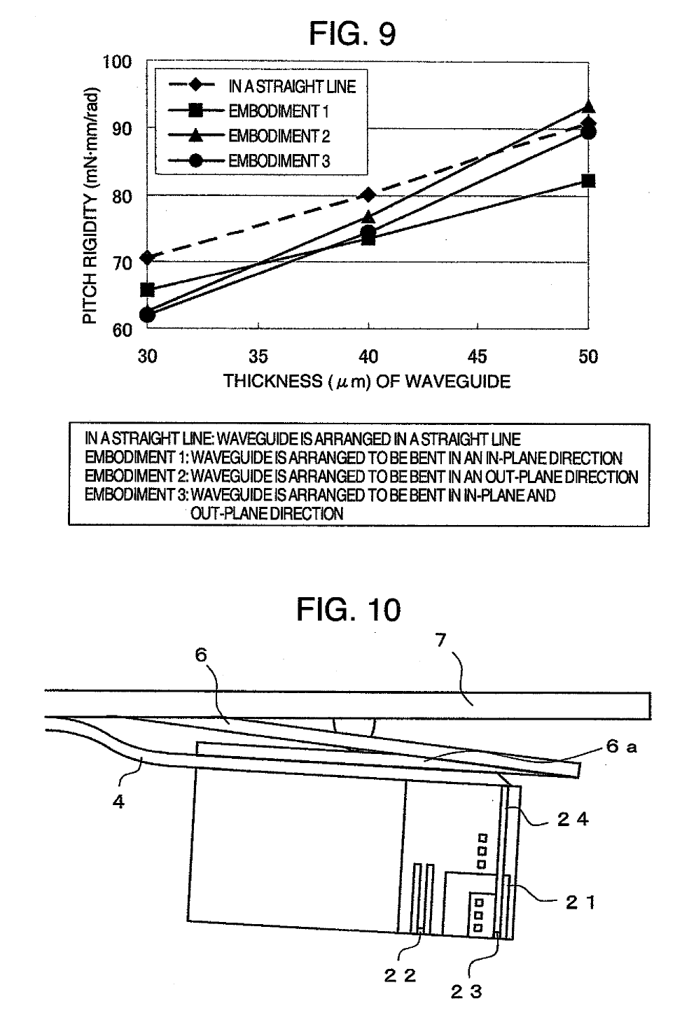

As an index for predicting an influence given by the stiffness of the waveguide 4 to the flying-heights and the attitudes of the slider 3, stiffness of the suspension 5 along a pitch direction 11 is selected. Then, a plurality of pitch constant as to the below-mentioned cases were calculated and compared with each other: namely, in the case that the waveguide 4 was arranged in a straight line; in the case that the waveguide 4 was bent along the in-plane direction, as explained in the embodiment 1; in such a case that the waveguide 4 was bent along the out-plane direction, as exemplified in the embodiment 2; and in such a case where the waveguide 4 was bent along the in-plane direction and the out-plane direction as described in the embodiment 3. FIG. 9 represents calculation results obtained when a distance between a fixed portion of the tip portion 6a of the flexure 6 and a fixed portion of the flexure 6 on the side of the carriage arm 8 is set to 5 mm, the radius of curvature is set to 15 mm, and a loading-force applied from the load beam 7 is set to 2 gf.

A sectional shape of the waveguide 4 is rectangular, and a width thereof is 100 μm, which is fixed. An abscissa indicates thicknesses of the waveguide 4. When a thickness of the waveguide 4 is 30 μm, pitch constant calculated in the case that the waveguide 4 is bent becomes smaller than pitch constant calculated in the case that the waveguide 4 is arranged in the straight line. In other words, in such a case that the waveguide 4 is bent, the stiffness of the waveguide 4 may give a smaller influence to the flying-heights and the attitudes of the slider 3. More specifically, in the case that the waveguide 4 is bent in the out-plane direction, the pitch constant becomes small.

However, in such a case that the waveguide 4 is bent in the out-plane direction, the thicker the thickness of the waveguide 4 becomes, the larger the pitch constant rapidly becomes. When a thickness of the waveguide 4 becomes 50 μm which is equal to a half value of the width thereof, pitch constant calculated in the case that the waveguide 4 is bent in the out-plane direction becomes larger than that calculated in such a case that the waveguide 4 is arranged in the straight line. This fact may be conceived from the below-mentioned reason: That is, in such a case that the waveguide 4 is bent in the out-plane direction, when the suspension 5 is bent along the pitch direction 11, this flexure is released, so that the stiffness of the waveguide 4 does not give an adverse influence to the pitch constant of the suspension 5. However, if the thickness of the waveguide 4 becomes thick, then stiffness with respect to deformation capable of releasing the flexure of the waveguide 4 is increased which may give a large influence also to the pitch constant of the suspension 5.

As a consequence, in the case that the waveguide 4 is bent in the out-plane direction, it is preferable to make the thickness of the waveguide 4 thinner, and is desirable to decrease the thickness thereof smaller than, or equal to at least a half width of the waveguide 4. In contrast to the above-explained exemplification, in such a case that the waveguide 4 is arranged by being bent in the in-plane direction, as exemplified in the embodiment 1, pitch constant of the suspension 5 becomes smaller than that calculated in such a case that the waveguide 4 is arranged in the straight line without having a play even when the thickness of the waveguide 4 becomes thick.

### Embodiment 5

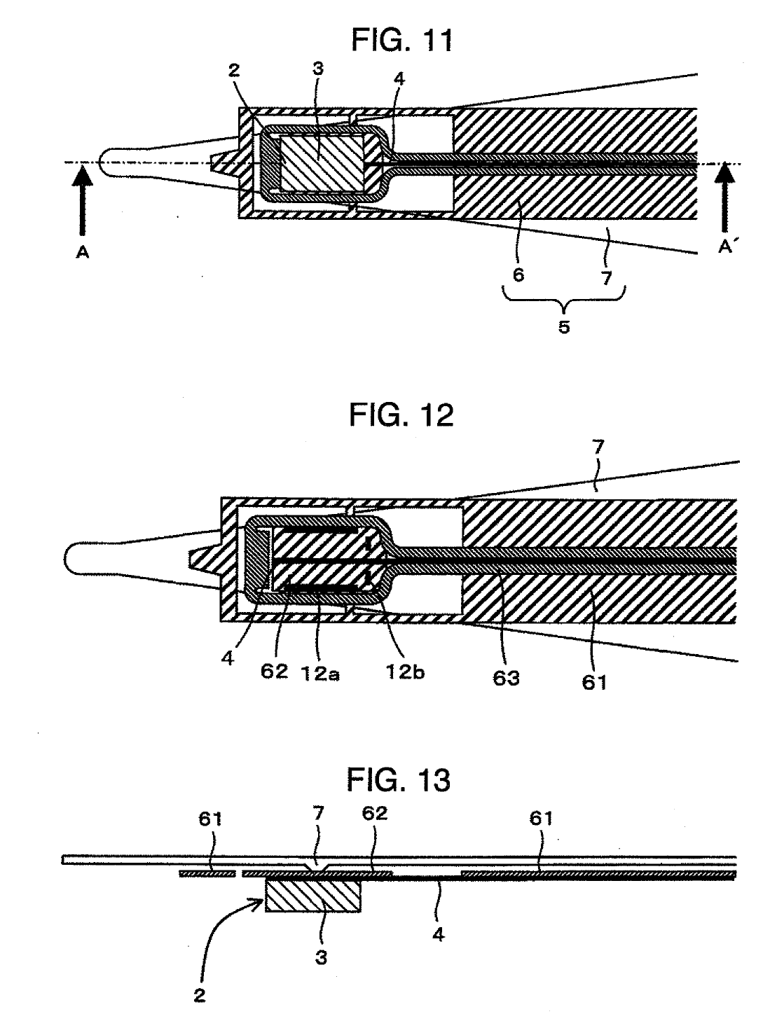

FIG. 11 is an enlarged view for showing a tip portion of a head supporting mechanism under such a condition that a slider has been mounted, according to an embodiment 5 of the present invention. FIG. 12 is an enlarged view for indicating a tip portion of the head supporting mechanism before the slider is mounted, according to the embodiment 5 of the present invention. FIG. 13 is a sectional view of the head supporting mechanism, taken along a line A-A′ of FIG. 11.

A flexure 6 which constructs a suspension 5 in combination with a load beam 7 is formed that, for instance, a plate member made of stainless steel is employed, the thickness of which is thin, and then, a notch is formed in a portion of the plate member. Thereafter, as illustrated in FIG. 12, the flexure 6 is constituted by a stainless substrate 61 and a slider joining plane 62, while the slider joining plane 62 is continued to the stainless substrate 61 by a twin cantilever. A circuit member 63, a waveguide 4, and auxiliary members 12a and 12b having the same thickness as that of the waveguide 4 are formed on the flexure 6. In this case, the circuit member 63 is a wiring member which is manufactured by stacking, for instance, polyimide, a copper wire, and polyimide in this order. The waveguide 4 is arranged at a center of the slider joining plane 62 of the flexure 6; the auxiliary member 12a having the same thickness as that of the waveguide 4 is arranged in the vicinity of both side edge portions (viewed along longitudinal direction) of the slider joining plane 62, and the auxiliary member 12a is located parallel to the waveguide 4; and furthermore, the auxiliary member 12b having the same thickness as that of the waveguide 4 is arranged in the vicinity of one edge portion of the slider joining plane 62 in such a manner that the auxiliary member 12b is intersected substantially perpendicular to the waveguide 4. While the slider 3 is connected to the slider joining plane 62 of the flexure 6 by an adhesive agent (not shown), the adhesive agent is piled up in a space defined between the waveguide 4 arranged at the center of the slider joining plane 62 of the flexure 6, and the auxiliary members 12a and 12b having the same thickness as that of the waveguide 4. Concretely speaking, although the adhesive agent (not shown) is piled up whose height is higher than that of the waveguide 4 in the beginning, the piled adhesive agent is depressed by the slider 3 so as to flow into the space between the slider 3 and the waveguide 4, and the spaces between the slider 3 and the auxiliary members 12a and 12b. As a result, the slider 3 may be connected to the slider joining plane 62 without any gap, and thus, the slider 3 may be connected to the slider joining plane 62 in high precision without any inclination.

As the heat assisted recording-purpose magnetic head 2, for instance, there is a magnetic head having such a structure that light is conducted from a portion located near the magnetic head 2 of the slider 3, as disclosed in “Flying demonstration and analysis of pico slider with optical waveguide for heat assisted magnetic recording” (The 19th Magnetic Recording Conference (TMRC) 2008, Singapore, Jul. 29 to 31, in 2008). In such a case that the slider 3 having the above-described structure is employed, in accordance with the present embodiment 5, as previously described, such a head structure is employed that the waveguide 4 is elongated up to the magnetic head 2 formed with the tip portion of the slider 3 in the integral manner, and furthermore, the waveguide 4 is directly connected to the slider 3. As a result, a loss occurred when the light is guided from the waveguide 4 to the magnetic head 2 can be reduced.

### Embodiment 6

An embodiment 6 of the present invention is featured by a hard disk drives head supporting mechanism without employing the conventional magnetic recording system, namely, the heat assisted recording system, while the waveguide 4 provided in the embodiment 5 is not employed.

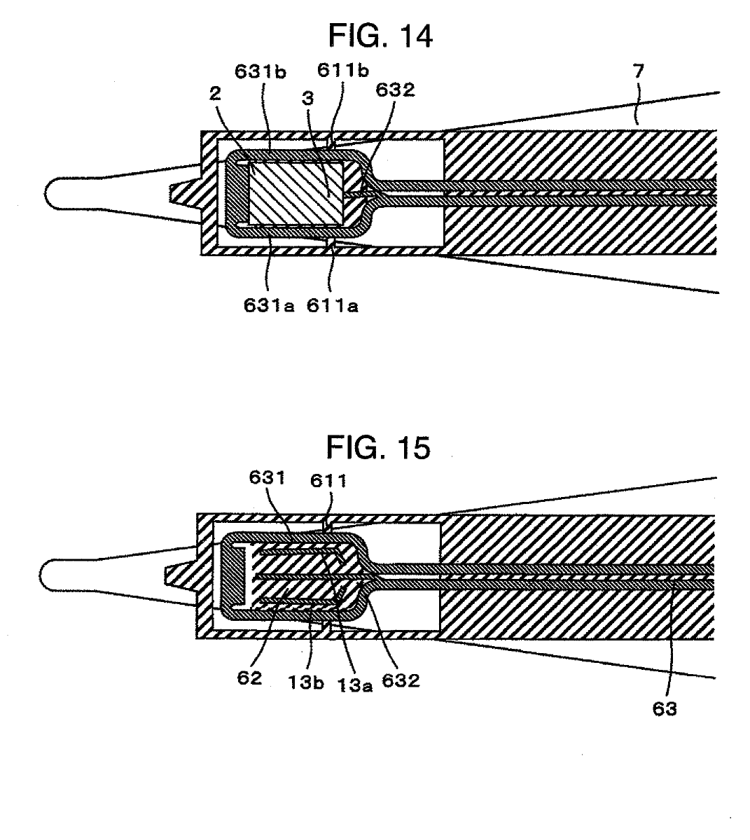

FIG. 14 is an enlarged view for showing a tip portion of a head supporting mechanism without having the above-described waveguide 4, according to the embodiment 6 of the present invention. FIG. 15 is a diagram for indicating such a condition obtained before a slider of the head supporting mechanism of FIG. 14 is mounted. It should be noted that the same reference numerals shown in the embodiment 5 will be employed as those for denoting the same structural components in these drawings.

Although a basic structure of the head supporting mechanism of the present embodiment 6 is identical to that of the embodiment 5, a portion of the circuit member 63 is employed instead of the waveguide 4 of the embodiment 5, and auxiliary members 13a and 13b having the same thickness as that of the circuit member 63 are employed instead of the auxiliary members 12a and 12b having the same thickness as that of the waveguide 4 of the embodiment 5. In FIG. 14, an arm 631 (arms 631a and 631b) of the circuit member 63 is not overlapped with the stainless substrate 61 of the flexure 6 except for such a portion which is overlapped with an arm 611 (arms 611a and 611b) of the stainless substrate 61 of the flexure 6. As a consequence, the slider joining plane 62 of the flexure 6 can be moved in a flexible manner. Concretely speaking with reference to FIG. 15, a portion 632 of the circuit member 63 is arranged by being elongated to a center portion of the slider joining plane 62 of the flexure 6. Moreover, the auxiliary members 13a and 13b having the same thickness as a thickness of the portion 632 of the circuit member 63 are arranged in the vicinity of both side edge portions of the slider joining plane 62 along a longitudinal direction thereof, which are located parallel to the portion 632 of the circuit member 63.

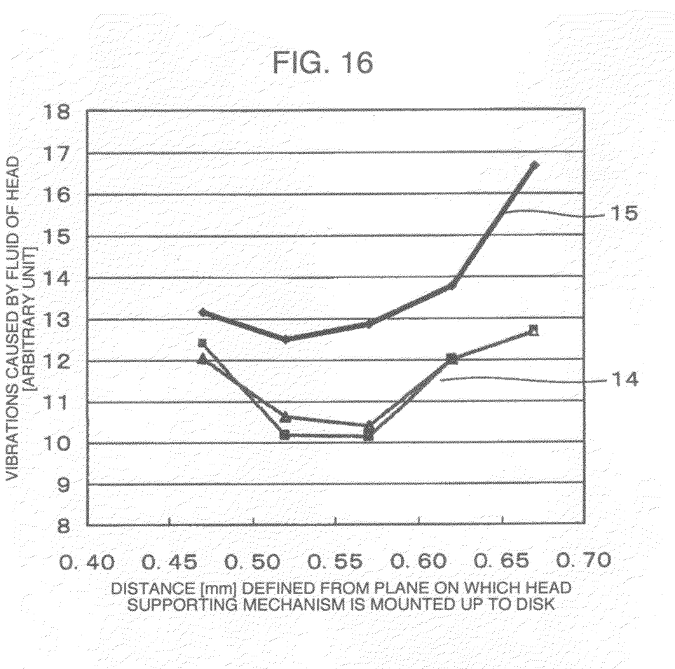

FIG. 16 is a graphic diagram for representing vibration characteristics of the head supporting mechanism, which indicate an effect of the embodiment 6. FIG. 16 indicates measurement results as to vibrations of the slider 3 along a lateral direction (longitudinal direction viewed on plane) when a head supporting mechanism having the same structure as that of FIG. 14 is arranged between rotary disks (not shown), namely, measurement results about vibrations which are caused by a fluid of a head. An abscissa indicates a distance defined from a plane on which the head supporting mechanism is mounted up to the disk. With respect to a vibration characteristic 14 of the head supporting mechanisms according to the present embodiment 6, another vibration characteristic 15 of a conventional head supporting mechanism without having the portion 632 of the circuit member 63 is large. This reason is given as follows: That is, relative vibrations produced by the slider joining plane 62 of the flexure 6 and the load beam 7 are suppressed by the portion 632 of the circuit member 63.

It should also be understood that similar to the embodiment 1, the slider 3 can be connected to the slider joining plane 62 in high precision without any inclination.

It should be further understood by those skilled in the art that although the foregoing description has been made on embodiments of the invention, the invention is not limited thereto and various changes and modifications may be made without departing from the spirit of the invention and the scope of the appended claims.

1. A head supporting mechanism comprising:
a slider equipped with a head having a recording element, a reproducing element, and a first waveguide;
a plate-shaped elastic member for supporting said slider;
an arm for supporting said plate-shaped supporting member; and
a second waveguide for guiding light to said slider; wherein:
a tip portion of said second waveguide is fixed to a portion of said plate-shaped elastic member, to which said slider is fixed; a portion of said second waveguide provided on the side of a light source is fixed to a portion of said plate-shaped elastic member, which is connected to said arm; and said second waveguide has a free portion between the fixed portion of said tip portion thereof and the fixed portion thereof provided on the side of said light source, while said free portion is bent in an in-plane direction of said plate-shaped elastic member.

2. A head supporting mechanism as claimed in claim 1 wherein:
said second waveguide is formed on said plate-shaped elastic member in an integral manner.

3. A head supporting mechanism comprising:
a slider equipped with a head having a recording element, a reproducing element, and a first waveguide;
a plate-shaped elastic member for supporting said slider;
an arm for supporting said plate-shaped supporting member; and
a second waveguide for guiding light to said slider; wherein:
a tip portion of said second waveguide is fixed to a portion of said plate-shaped elastic member, to which said slider is fixed; a portion of said second waveguide provided on the side of a light source is fixed to a portion of said plate-shaped elastic member, which is connected to said arm; and said second waveguide has a free portion between the fixed portion of said tip portion thereof and the fixed portion thereof provided on the side of said light source, while said free portion is bent in an out-plane direction of said plate-shaped elastic member.

4. A head supporting mechanism as claimed in claim 3 wherein:
a sectional shape of said second waveguide is rectangular, and a thickness of said second waveguide is smaller than, or equal to a half value of a width thereof.

5. A head supporting mechanism as claimed in claim 3 wherein:
said second waveguide is formed on said plate-shaped elastic member in an integral manner.

6. A head supporting mechanism comprising:
a slider equipped with a head having a recording element, a reproducing element, and a first waveguide;
a plate-shaped elastic member for supporting said slider;
an arm for supporting said plate-shaped supporting member; and
a second waveguide for guiding light to said slider; wherein:
a tip portion of said second waveguide is fixed to a portion of said plate-shaped elastic member, to which said slider is fixed; a portion of said second waveguide provided on the side of a light source is fixed to a portion of said plate-shaped elastic member, which is connected to said arm; and said second waveguide has a free portion between the fixed portion of said tip portion thereof and the fixed portion thereof provided on the side of said light source, while said free portion is bent in an in-plane direction and also an out-plane direction of said plate-shaped elastic member.

7. A head supporting mechanism as claimed in claim 6 wherein:
a sectional shape of said second waveguide is rectangular, and a thickness of said second waveguide is smaller than, or equal to a half value of a width thereof.

8. A head supporting mechanism as claimed in claim 6 wherein:
said second waveguide is formed on said plate-shaped elastic member in an integral manner.

9. A hard disk drive comprising:
a magnetic recording medium for recording thereon at least information;
a slider having a magnetic head at an end portion thereof, which writes, or reads the information with respect to the magnetic recording medium; and
a head supporting mechanism equipped with a plate-shaped elastic supporting member having a slider joining plane at a portion thereof, on which said slider is mounted, while in said head supporting mechanism, a circuit member electrically connected to said magnetic head and a waveguide for guiding light supplied from a light source to said magnetic head are provided on said plate-shaped elastic supporting member; wherein:
said waveguide is arranged at a center portion of said slider joining plane along a longitudinal direction of the slider joining plane;
while said waveguide is elongated from one end of said slider joining plane, which is located opposite to said magnetic head, a portion of the waveguide elongated from one end of said slider joining plane, which is located opposite to said magnetic head, is connected to either said elastic supporting member or said circuit member; and
an auxiliary member having the substantially same thickness as a thickness of said waveguide is provided on said slider joining plane.

10. A hard disk drive as claimed in claim 9 wherein:
said auxiliary member is a first auxiliary member having the substantially same thickness as that of said waveguide, which is arranged at both end portions of said slider joining plane along a longitudinal direction of the slider joining plane, and which is located parallel to said waveguide.

11. A hard disk drive as claimed in claim 10 wherein:
a second auxiliary member having the substantially same thickness as that of said waveguide is provided, while said second auxiliary member is arranged on one end of said slider, which is located opposite to said magnetic head, along a lateral direction of said slider joining plane in such a manner that said second auxiliary member is intersected perpendicular to said waveguide.

12. A hard disk drive comprising:
a magnetic recording medium for recording thereon at least information;
a slider having a magnetic head at an end portion thereof, which writes, or reads the information with respect to the magnetic recording medium; and
a head supporting mechanism equipped with a plate-shaped elastic supporting member having a slider joining plane at a portion thereof, on which said slider is mounted, while in said head supporting mechanism, a circuit member electrically connected to said magnetic head is provided on said plate-shaped elastic supporting member; wherein:
a portion of said circuit member is arranged at a center portion of said slider joining plane along a longitudinal direction of the slider joining plane;
while the portion of said circuit member is elongated from one end of said slider joining plane, which is located opposite to said magnetic head, said portion of the circuit member elongated from one end of said slider joining plane, which is located opposite to said magnetic head, is connected to either said elastic supporting member or said circuit member; and
an auxiliary member having the substantially same thickness as a thickness of the portion of said circuit member is provided on said slider joining plane.

13. A hard disk drive as claimed in claim 12 wherein:
said auxiliary member is a first auxiliary member having the substantially same thickness as that of the portion of said circuit portion, which is arranged at both end portions of said slider joining plane along a longitudinal direction of the slider joining plane, and which is located parallel to the portion of said circuit member.

14. A hard disk drive as claimed in claim 13 wherein:
a second auxiliary member having the substantially same thickness as that of the portion of said circuit member is provided, while said second auxiliary member is arranged on one end of said slider, which is located opposite to said magnetic head, along a lateral direction of said slider joining plane in such a manner that said second auxiliary member is intersected perpendicular to the portion of said circuit member.

15. A head supporting mechanism comprising:
a plate-shaped elastic supporting member having a slider joining plane at a portion thereof, on which a slider is mountable and in which said slider has a magnetic head for writing, or reading information with respect to a magnetic recording medium at an end portion of said slider, while in said head supporting mechanism, a circuit member electrically connected to said magnetic head and a waveguide for guiding light supplied from a light source to said magnetic head are provided on said plate-shaped elastic supporting member; wherein:
said waveguide is arranged at a center portion of said slider joining plane along a longitudinal direction of the slider joining plane;
while said waveguide is elongated from one end of said slider joining plane, which is located opposite to said magnetic head, a portion of the waveguide elongated from one end of said slider joining plane, which is located opposite to said magnetic head, is connected to either said elastic supporting member or said circuit member; and
an auxiliary member having the substantially same thickness as a thickness of said waveguide is provided on said slider joining plane.

16. A head supporting mechanism as claimed in claim 15 wherein:
said auxiliary member is a first auxiliary member having the substantially same thickness as that of said waveguide, which is arranged at both end portions of said slider joining plane along a longitudinal direction of the slider joining plane, and which is located parallel to said waveguide.

17. A head supporting mechanism as claimed in claim 16 wherein:
a second auxiliary member having the substantially same thickness as that of said waveguide is provided, while said second auxiliary member is arranged on one end of said slider, which is located opposite to said magnetic head, along a lateral direction of said slider joining plane in such a manner that said second auxiliary member is intersected perpendicular to said waveguide.

18. A head supporting mechanism comprising:
a plate-shaped elastic supporting member having a slider joining plane at a portion thereof, on which a slider is mountable and in which said slider has a magnetic head for writing, or reading information with respect to a magnetic recording medium at an end portion of said slider, while a circuit member which is electrically connected to said magnetic head is provided on said elastic supporting member; wherein:
a portion of said circuit member is arranged at a center portion of said slider joining plane along a longitudinal direction of the slider joining plane;
while the portion of said circuit member is elongated from one end of said slider joining plane, which is located opposite to said magnetic head, said portion of the circuit member elongated from one end of said slider joining plane, which is located opposite to said magnetic head, is connected to either said elastic supporting member or said circuit member; and
an auxiliary member having the substantially same thickness as a thickness of the portion of said circuit member is provided on said slider joining plane.
